(19) United States
(12) Patent Application Publication
(10) Pub. No.: US 2007/0136690 A1
(43) Pub. Date: Jun. 14, 2007

(54) Wedge menu

(75) Inventors: Matthew B. MacLaurin, Woodinville, WA (US); Lili Cheng, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/299,851

(22) Filed: Dec. 12, 2005

(51) Int. Cl. G06F 9/00

(52) U.S. Cl. 715/822; 715/834; 715/856; 715/859

(57) ABSTRACT

A unique menu user interface that facilitates more efficient viewing and selection of menu items is provided. The menu user interface involves arranging a plurality of menu items around a semicircular portion of an action area. The action area is constructed by creating a circle centered about a cursor or pointer. Thus, the menu items are arranged in an arc-like manner to one side of the action area to allow the user to interact with other onscreen content apart from the menu and menu items. Each menu item also includes an extension or extended portion that extends from the rectangular portion of the menu item to about the center of the semicircle. The extension on each menu item creates a larger selectable area for each item. In addition, it allows each item to have a distinct visual shape or appearance, both of which improve the user's viewing and selection capabilities.

### BACKGROUND

In recent years, computer program displays and the navigation thereof have improved greatly to become more user-friendly for various types and ages of users. For example, to accommodate the needs of much younger users, such as those who are just learning to read and/or use computers, have been designed. Some children, who in general, may be less detail oriented, require simpler picture-based. displays to facilitate viewing and navigation of the display. Similarly, users with poor vision may require larger-sized display features and text to make viewing and navigation easier. Despite the many advancements made in this area to accommodate many different users and skill levels, a higher degree of accuracy is still required to perform relatively easy actions such as selecting an item from a menu.

Conventional drop-down menus may not be that efficient for some or most users as a significant amount of accuracy is required to make the desired selection. Pie menus have attempted to make item selection easier. However, they remain problematic. For example, imagine a list of contact names is displayed to a user. When the user selects or hovers over a name, a pie menu with some number of options can open around (e.g., surrounding) the name. Because pie menu options surround the location of the cursor (e.g., the name), the user must completely exit the menu before moving the cursor up or down the name list to hover over or choose a different name. Thus, pie menus can be rather ineffective and inefficient because they cover too much real estate.

### SUMMARY

The following presents a simplified summary in order to provide a basic understanding of some aspects of the user interface, systems and/or methods discussed herein. This summary is not an extensive overview of the systems and/or methods discussed herein. It is not intended to identify key/critical elements or to delineate the scope of such user interface, systems and/or methods. Its sole purpose is to present some concepts in a simplified form as a prelude to the more detailed description that is presented later.

The subject application relates to a user interface (s) and/or methodology that facilitate improved menu item viewing and selection. In particular,

The subject application relates to a user interface (s) and/or methodology that facilitate improved menu item viewing and selection. In particular, the menu user interface allows a user to be less precise and/or less accurate when highlighting or selecting an item from the menu while still providing the user with vertical and/or horizontal mobility with respect to any other onscreen content apart from the menu. This can be accomplished at least in part by constraining the menu items to a portion of a circular area in an arc-like configuration—as opposed to arranging the menu items around the whole circle as is done in conventional pie menus. The circular area can be referred to as an action area and is created around a cursor or other pointer. When the user activates or opens a menu, the menu items which are constrained to a portion of the action area can be presented to the user. More specifically, the menu items can be positioned on one side of the cursor. Thus, the user can still easily access the onscreen user interface (e.g., object stack or list or other content displayed onscreen) apart from the menu construct.

According to one approach, the menu items can be arranged in a semicircle with arcs extending to the center of the semicircle. Each arc can be highlighted as the cursor passes over it. Because the menu items can be extended to the center of the semicircle, the user may select between them while only moving the cursor (e.g., via a pointing device) a very short distance—compared to the distance required by traditional menu user interfaces. The menu items and their extensions can regularly divide the area of the semicircle, thereby making each item equally easily selectable. Furthermore, a larger selectable area per item is created through the employment of such menu item extensions. Consequently, users who lack fine motor skills can manipulate their pointing device further out from the center of the circle or circular area and still access the desired menu item.

In addition, each menu item can exhibit a distinct visual appearance or shape to further distinguish each item apart from the others. As a result, recognition and selection of a desired menu item can be performed by the user with greater ease.

The arrangement of menu items can dynamically change depending on the location of the menu on the display screen. For example, if the cursor is near or at the bottom of the display, the menu items can be arranged or rearranged automatically from a semicircle to an upper portion or quadrant of the semicircle. When appropriate, the menu items can be dynamically located at a lower portion of the semicircle such as when the menu is activated near or at the top of a page. In general, the menu as described herein can be oriented vertically or horizontally.

To the accomplishment of the foregoing and related ends, certain illustrative aspects of the invention are described herein in connection with the following description and the annexed drawings. These aspects are indicative, however, of but a few of the various ways in which the principles of the invention may be employed and the subject invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of an exemplary menu user interface as visualized on a display screen with respect to an object stack.

FIG. 2 is a block diagram that demonstrates the arrangement and/or formation of each menu item (wedge) with respect to a semicircular portion of an action area.

FIG. 3 is a block diagram illustrating an exemplary activation of the wedge menu as may be performed by a user.

FIG. 4 illustrates two view of an exemplary wedge menu to demonstrate the position of the menu with respect to a user's cursor or action area as well as the visual appearance each menu item is given through the use of extensions from the menu item to the center of the action area.

FIG. 5 is a block diagram of an exemplary wedge menu as laid out with respect to an action area (shaded).

FIG. 6 is a block diagram of an exemplary wedge menu as laid out with respect to an action area (shaded).

FIG. 7 is a block diagram of an exemplary wedge menu as laid out with respect to an action area (shaded).

FIG. 8 is a block diagram of an exemplary wedge menu as laid out with respect to an action area (shaded).

FIG. 9 is a block diagram of an exemplary wedge menu as laid out with respect to an action area (shaded).

FIG. 10 illustrates an exemplary menu user interface that has been activated with respect to a user's contact list.

FIG. 11 is a flow chart illustrating an exemplary methodology that facilitates fabricating a wedge menu to improve menu item selection.

FIG. 12 illustrates an exemplary environment for implementing various aspects of the invention.

### DETAILED DESCRIPTION

The subject systems and/or methods are now described with reference to the drawings, wherein like reference numerals are used to refer to like elements throughout. In the following description, for purposes of explanation, numerous specific details are set forth in order to provide a thorough understanding of the systems and/or methods. It may be evident, however, that the subject systems and/or methods may be practiced without these specific details. In other instances, well-known structures and devices are shown in block diagram form in order to facilitate describing them.

As used herein, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers.

The subject systems and/or methods can incorporate various inference schemes and/or techniques in connection with generating a wedge menu dynamically. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Software users frequently need to select from an array of choices. Existing systems make it difficult for end-users to quickly and efficiently select a desired item. As discussed herein, the wedge menu provides at least on strategy to increase efficiency of selection from amongst a number of choices in a graphical user interface that mitigates challenging limitations introduced or imposed by conventional menus.

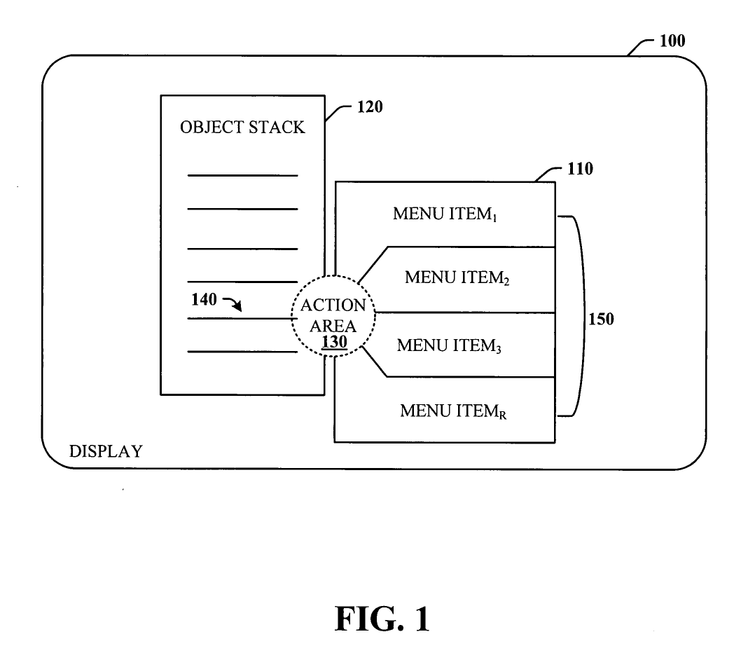

Referring now to FIG. 1, there is a general block diagram of an exemplary user display 100 on which a wedge menu 110 has been activated by a user. The wedge menu 110 corresponds to an object stack 120 that the user may be viewing. When the user hovers over or clicks on an object 140 (or object button), an action area 130 associated with a wedge menu can be activated to reveal a plurality of menu items 150. The action area 130 can be centered around the user's cursor. Unlike a traditional menu, the wedge menu items 150 are arranged around a portion of the cursor or action area 130. More importantly, the wedge menu items 150 do not fully surround the cursor or action area 130. Rather, the menu items 150 can be constrained to one side of the cursor or action area 130 as demonstrated in the display 100, thereby preserving the mobility of the user's cursor with respect to any other objects in the object stack 120 or any other content on the display.

To further improve viewing and selectability of the menu items, each menu item 150 can extend to about the center of the action area 130. This makes selection of any one menu item much more efficient for the user since the user is only required to move the cursor a short distance. Accuracy of menu item selection can also be improved since each menu item has a greater selectable area. Thus, the user is given easier access to the desired item.

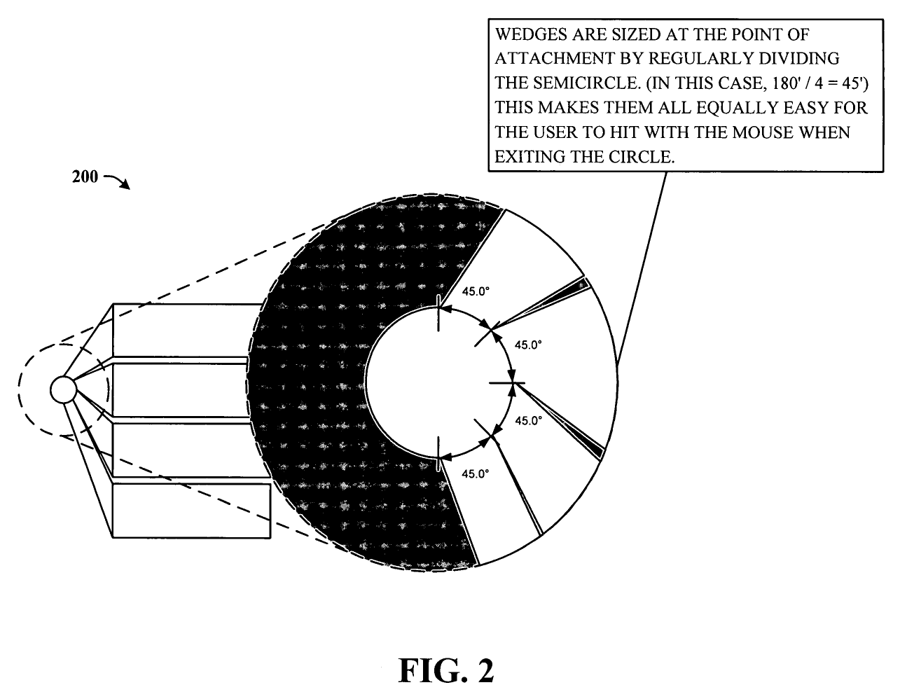

Turning now to FIG. 2, there is a block diagram 200 that demonstrates one exemplary manner in which wedge menu items can be generated and arranged with respect to an action area. Imagine that a user is using a computer having a graphical user interface and a pointing device. A computer program requires the user to choose between an array of different options. To accomplish this, one or more menus comprising an array of individual choices or menu items can be created.

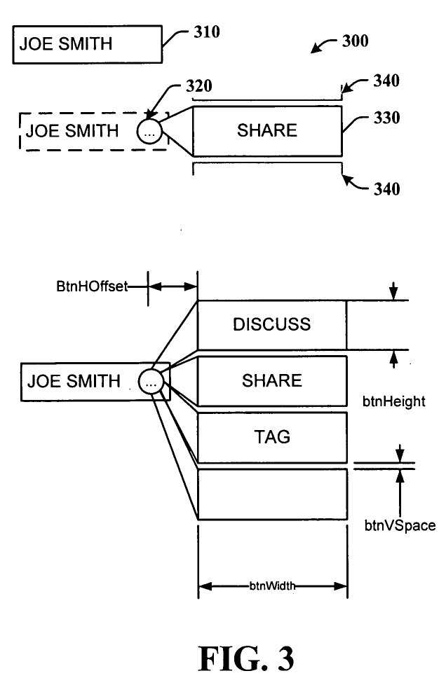

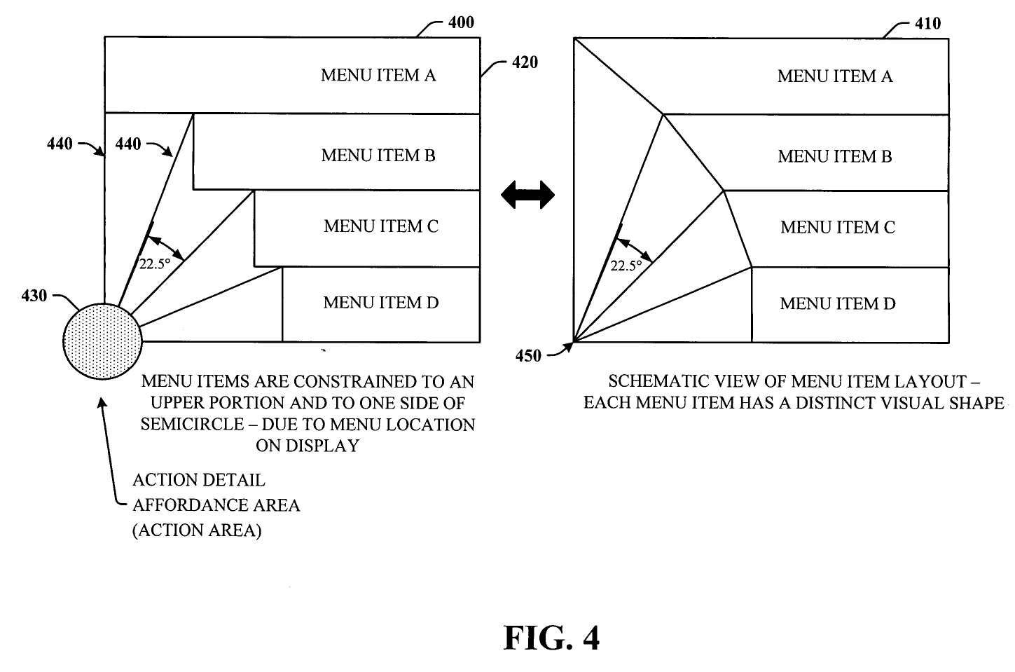

For any one menu, the menu items are arrayed as follows: a semicircle (or the right-hand half of a two-dimensional circle) is constructed wherein the center of the semicircle (or circle) is the approximate location of the mouser cursor (or a nearby position as indicated by the application programmer). The height of the semicircle is taken as H*(N +2) where H is the height of a menu item (see FIG. 3, infra), and N is the total number of items to be displayed. The semicircle is subdivided into N+2 sections, where N is the number of items to be presented to the user. The first and last subdivisions or arcs of the semicircle can be discarded. All remaining arcs are used to arrange the menu items spatially as follows: the first item is placed with its top-left corner located at the beginning of the first arc; and the second item is placed with its top-left corner located at the beginning of the second arc. Each menu item—initially appearing as a rectangle—is extended by extending lines from the left-hand corners (upper and lower) to the center of the semicircle, creating a triangle which is then visually connected to the original item rectangle (see FIG. 4, infra, for more on this). The items can then be presented to the user when the menu is triggered. As the user positions the mouse over the various items, they are highlighted to indicate that they are available for selection.

In practice, the menu items (or wedges) can be sized at the point of attachment to a semicircular portion of the action area in part by regularly dividing the semicircle by the desired number of wedge menu items. For example, when the menu is to include 4 menu items for the user to choose from, divide 180 degrees by 4. The result is 45 degrees which signifies that the menu items are spaced about 45 degrees apart. Thus, the menu items can be equally and easily hit with a mouse cursor or other pointing device when exiting the circle to make a menu item selection. It should be appreciated that any number of menu items can be included in the wedge menu and presented to the user. Furthermore, one or more menu items can be associated with an additional wedge menu. This type of configuration may also be referred to as cascading wedge menus.

The block diagram 300 pictured in FIG. 3 illustrates an exemplary user interface for a wedge menu and an exemplary technique for the selection of a menu item as described in FIG. 2. Each menu item can be initialized as a rectangle enclosing its textual name (e.g., Joe Smith). The height of a representative item can be calculated using a font and text measure selected by the application programmer.

As shown in FIG. 3, the button 310 (e.g., Joe Smith) may display no action area (also referred to as action detail affordance) when at rest. As the pointing device enters the button 310 and a first time interval (T1) has elapsed, an action detail affordance 320 as well as a default action 330 (e.g., “share”) can be displayed. If the user has not committed to an action (via selecting a menu item) after a second time interval (T2) has elapsed, then transparent, partial frames 340 above and/or below the default action 330 can be made visible to the user to indicate that there are additional options from which the user may make a selection. It should be appreciated that the action detail affordance area 320 may be identified by a symbol, icon, or other graphic (e.g., three dots). Such symbol, icon, or graphic can be animated such as to improve its visibility to the user or when the user has moved its pointing device over or in the area 320.

Alternatively, as the pointing device enters the action detail affordance area 320, a plurality of the available menu options 350 (e.g., “discuss”, “share”, “tag”, etc.) may be readily shown to the user. The user may release the pointing device at this point without committing to a particular action (e.g., making a selection of any one menu item).

Turning now to FIG. 4, there are block diagrams 400, 410 of two different views of an exemplary wedge menu which has been generated as described in FIG. 2, supra. In the first diagram 400, the menu items 420 are shown in relation to an action area 430. The lines 440 extending from each rectangle to the center of the action area 430 that form each item's extension can be seen as well. In this particular wedge menu layout, the menu items 420 are constrained to one side (e.g., right side) of the action area 430 (e.g., right semicircle). In addition, the menu items 420 are confined to an upper portion of the semicircle. This may be due to the location of the menu with respect to the display area. It should be understood that the menu items 420 can be constrained to any one portion of the action area 430. For example, when dealing with a vertically oriented object stack and wedge menu, the menu items 430 can be arranged to either the left or right side of the action area 430.

The other diagram 410 demonstrates a different view of the menu item layout. In particular, the diagram 410 more clearly depicts the distinct visual shape of each menu item—including the arc extensions of each menu item. The initial rectangular shape of the menu item can be seen in combination with the triangular shaped extension extending therefrom. Though not specifically shown in the diagram 410, the endpoints 450 of the triangular portions can meet in the center of the action area 430. As a result of the unique shape of each menu item, the user can more readily distinguish between menu items, thus making item viewing and selection more efficient and more accurate.

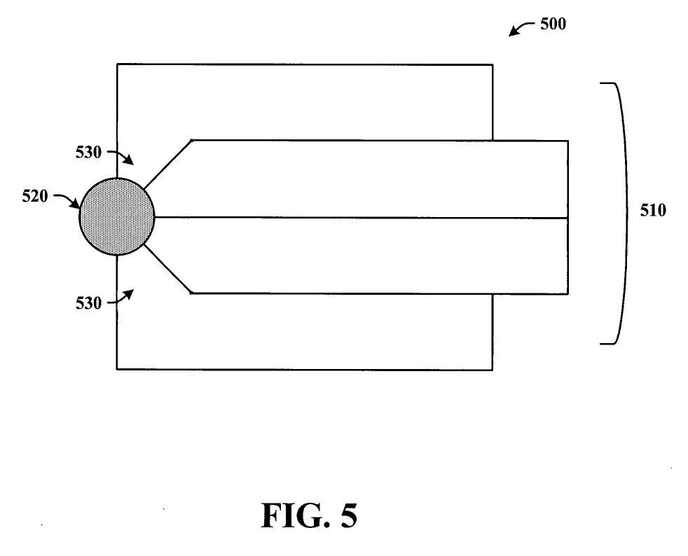

Referring now to FIGS. 5-9, there are illustrated multiple variations of the user interface for the wedge menu. For example, in FIG. 5, the wedge menu 500 includes 4 menu items 510 that are evenly spaced around a semicircular portion of an action area 520 (shaded). The menu items 510 are vertically oriented; however, it should be appreciated that in the alternative, they may be arranged in a horizontal manner as well. In general, the arrangement of the menu items as well as the extensions 530 associated therewith facilitates a more efficient and a more effective user interaction with the menu 500.

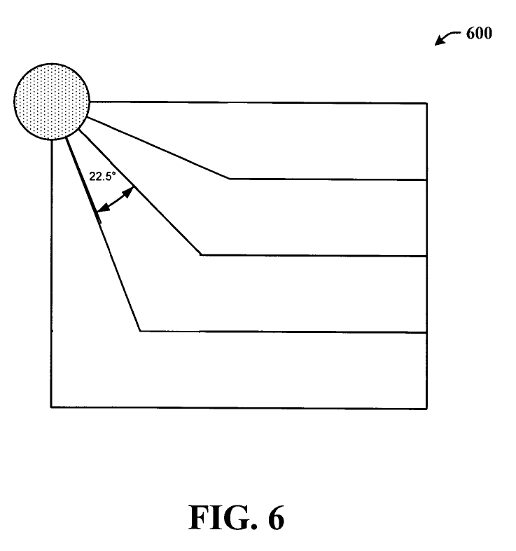

In FIG. 6, the wedge menu 600 includes a plurality of menu items 610 that are restrained to a portion of the semicircular region of an action area 620. In particular, the menu items 610 may be arranged in a lower portion of the action area 620 which can be useful when visible display space is limited.

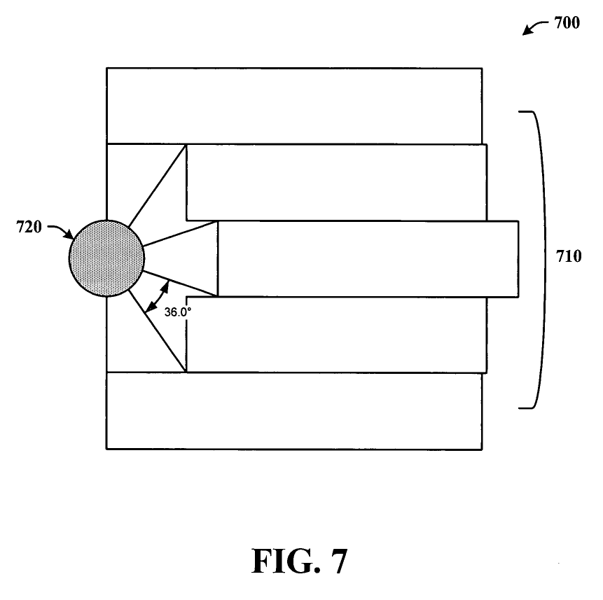

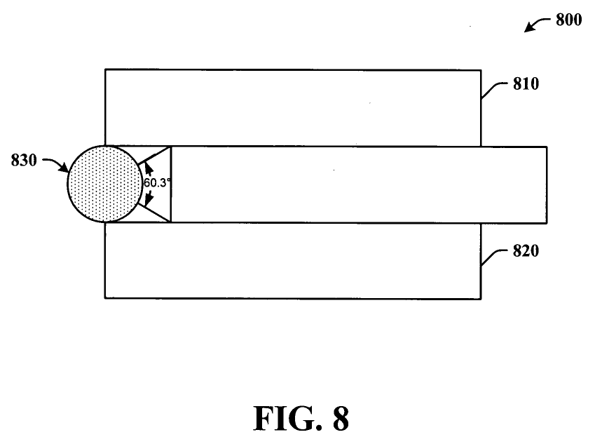

FIGS. 7 and 8 demonstrate wedge menus 700, 800 with varying numbers of menu items and the resulting appearance of each item. In FIG. 7, there are 5 menu options 710. Looking at the rectangular portion of each option 710, the arc arrangement of the menu options 710 around the right-half of the action area 720 is evident. A similar observation can be made with respect to the wedge menu 800 in FIG. 8. In FIG. 8, however, the top and bottom menu items (810, 820) do not extend from the action area 830 as previously described hereinabove. Instead, only the middle menu item includes an extension that extends from about the center of the action area 830 (endpoint of extension hidden from view).

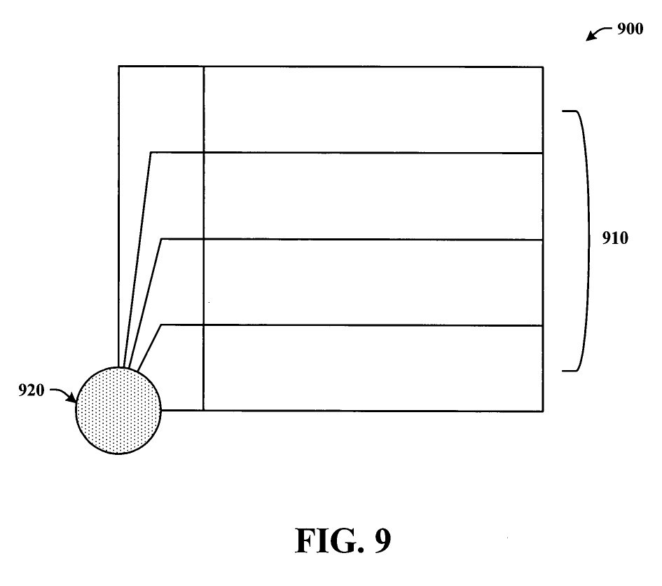

The menu 900 in FIG. 9 illustrates yet another variation of a wedge menu. In this menu 900, the menu items 910 have been constrained to an upper half of the semicircular portion of the action area 920. Unlike the other wedge menus discussed herein, the menu items 910 and particularly their extensions are not equally spaced apart. However, each menu item still exhibits a distinct visual shape for easier recognition.

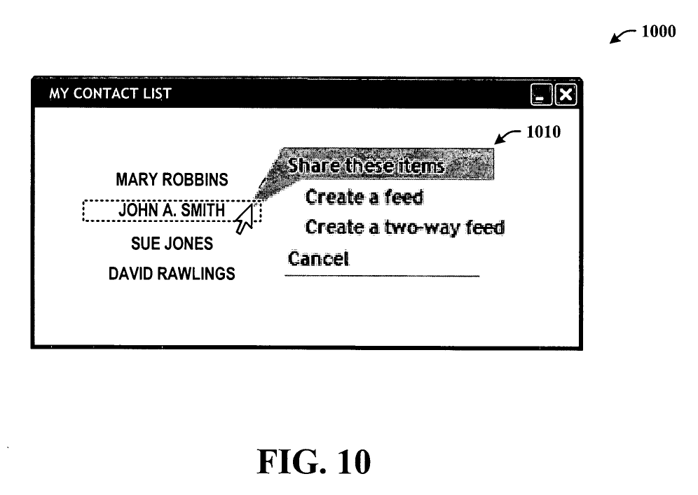

Turning now to FIG. 10, there is a screen capture of an exemplary user interface 1000 for a wedge menu 1010 that has been activated by user as described hereinabove. In this figure, a user is viewing his contact list and can perform a number of operations with a desired contact. To view and select an operation, the user can activate the menu by hovering over or clicking on the desired contact (e.g., John A. Smith) for a time (T). For example, when time T elapses, the contact can be illuminated (as indicated by the dashed box) in some manner to indicate the position of the cursor to the user.

The available menu options can appear to the right of the user's cursor. As the user's cursor passes over the option, the option can be highlighted. Because each menu option has an extension in close proximity to the cursor, the user only needs to move the cursor a very short distance to make his desired selection. The extension on each menu option also increases the selectable area of each option, thereby mitigating the need for fine motor skills when maneuvering the cursor to make a selection.

The menu and menu options included therein appear to one side of the contact list. This makes it feasible for the user to easily and quickly exit the menu for the current contact and move his cursor to another name on the list or in the alternative, to another area on the screen. Thus, vertical movement along the contact list is maintained while at the same time allowing the user to be less precise in making a selection from the menu. Conventional menus either consume too much screen real estate, thus, limiting the user's mobility along the list or require fine motor skills and selection precision on the part of the user.

Various methodologies will now be described via a series of acts. It is to be understood and appreciated that the subject system and/or methodology is not limited by the order of acts, as some acts may, in accordance with the subject application, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject application.

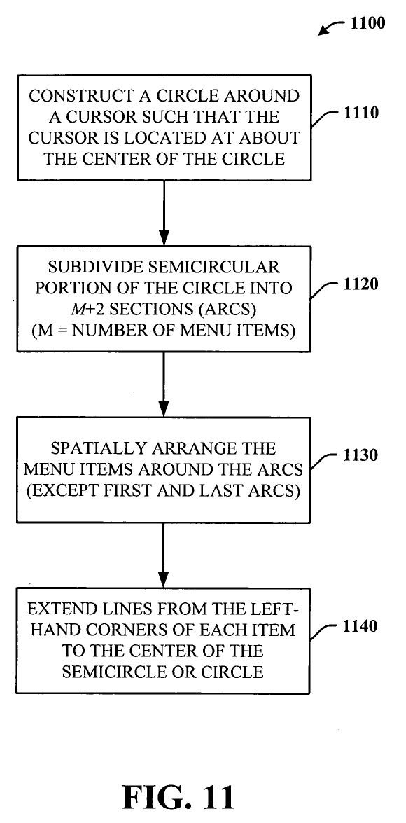

Referring now to FIG. 11, there is a flow diagram of an exemplary method 1100 that facilitates generating a wedge menu that provides more efficient selection of a menu item. The method 1100 involves constructing a circle around a cursor such that the cursor is located at about the center of the circle at 1110. At 1120, a semicircular portion of the circle is subdivided into m+2 sections, where m is the number of items to be included in the menu and presented to the user. The first and last subdivisions of the semicircle are discarded or not used.

At 1130, the remaining arcs can be used to spatially arrange the menu items such as in an evenly distributed manner. In particular, the first menu item can be placed with its top-left corner located at the beginning of the first arc. The second menu item can be placed with its top-left corner located at the beginning of the second arc, and so on for the remaining menu items. Each item may initially appear in the shape of a rectangle, but at 1140, each item can be extended by extending lines from the left-hand corners to the center of the semicircle or circle. A triangular shape results therefrom, which allows each item to take on a distinctive shape or appearance. Hence, visual recognition of the menu items is substantially improved.

The resulting menu includes an arc-based layout of menu items that are arranged around an arc centered about a portion of the user's cursor but that do not surround the cursor. Each arc is highlighted or otherwise illuminated as the user passes over it. Thus, the extent of user movements needed to make a selection is decreased. Furthermore, the menu items are located on one side of the cursor, thereby affording the user the ability to easily move about the display screen apart from the menu and quickly perform other actions or make other selections apart from the menu.

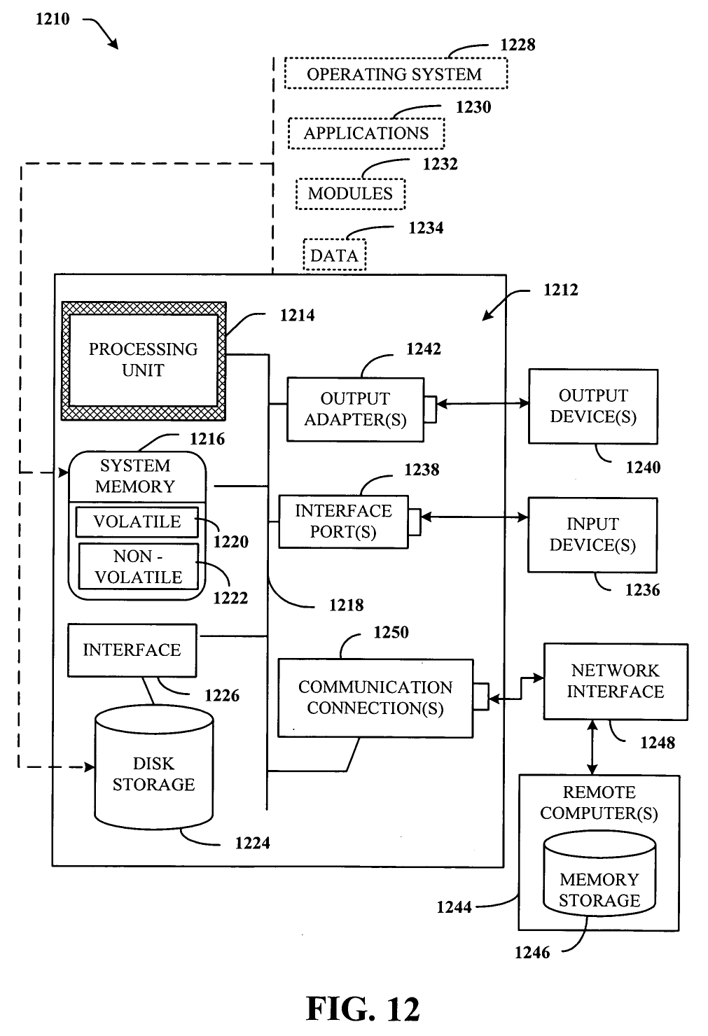

In order to provide additional context for various aspects of the subject application, FIG. 12 and the following discussion are intended to provide a brief, general description of a suitable operating environment 1210 in which various aspects of the subject application may be implemented. While the system(s) and/or method(s) is described in the general context of computer-executable instructions, such as program modules, executed by one or more computers or other devices, those skilled in the art will recognize that the invention can also be implemented in combination with other program modules and/or as a combination of hardware and software.

Generally, however, program modules include routines, programs, objects, components, data structures, etc. that perform particular tasks or implement particular data types. The operating environment 1210 is only one example of a suitable operating environment and is not intended to suggest any limitation as to the scope of use or functionality of the system and/or method. Other well known computer systems, environments, and/or configurations that may be suitable for use with the system and/or method include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 12, an exemplary environment 1210 for implementing various aspects of the system and/or method includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MCA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable ROM (EEPROM), or flash memory. Volatile memory 1220 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1212 also includes removable/nonremovable, volatile/nonvolatile computer storage media. FIG. 12 illustrates, for example a disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in suitable operating environment 1210. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that the subject system and/or method can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212 and to output information from computer 1212 to an output device 1240. Output adapter 1242 is provided to illustrate that there are some output devices 1240 like monitors, speakers, and printers among other output devices 1240 that require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems and DSL modems, ISDN adapters, and Ethernet cards.

What has been described above includes examples of the subject system and/or method. It is, of course, not possible to describe every conceivable combination of components or methodologies for purposes of describing the subject system and/or method, but one of ordinary skill in the art may recognize that many further combinations and permutations of the subject system and/or method are possible. Accordingly, the subject system and/or method are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising”as “comprising” is interpreted when employed as a transitional word in a claim.

What is claimed is:

1. A menu user interface that facilitates improved menu item selection comprising:
an action area constructed around a pointer; and
a plurality of menu items arranged in an arc and centered around the pointer in a semicircular portion of the action area, thereby maintaining the pointer's mobility to easily move about a display space apart from the menu user interface.

2. The user interface of claim 1, the action area is circular.

3. The user interface of claim 1, the pointer is a cursor.

4. The user interface of claim 1, the plurality of menu items do not surround the pointer.

5. The user interface of claim 1, the pointer is located at about a center of the action area.

6. The user interface of claim 1, the menu items comprise a rectangular shape that is extended by two lines extending from upper and lower corners of one side of the rectangular shape and meeting at about the center of the action area to create a triangular portion that is visually connected to the rectangular portion.

7. The user interface of claim 1, the menu items each have a distinctive visual shape that improves visual recognition of each menu item.

8. The user interface of claim 1, the plurality of menu items are arranged equally apart from one another in the semicircular portion of the action area.

9. The user interface of claim 8, an angle at which each menu item is positioned in the semicircular portion is determined by dividing 180 by the number of desired menu items to be presented to a user.

10. The user interface of claim 1, the plurality of menu items comprising a default menu item that is presented first to a user before any other available menu items.

11. The user interface of claim 1, the plurality of menu items comprise a larger selectable area per item, thereby mitigating a user's need of selection precision or fine motor skills.

12. The user interface of claim 1, the menu items are any one of vertically or horizontally oriented.

13. An arc-based menu user interface comprising:
a circular action area constructed around a cursor such that the cursor is at or near the center of the circular action area; and
more than one menu item arranged in an arc-like manner along one side of the circular action area, each menu item comprising a rectangular portion, the rectangular portion comprising text, and a triangular portion extending from the rectangular portion to the center of the circular action area to provide a larger selectable area for each menu item, thus facilitating selection of a desired menu item with more efficiency and accuracy.

14. The user interface of claim 13, the menu items are arranged vertically along a right side of the circular action area.

15. The user interface of claim 13, the triangular portion creates a distinct visual shape to each menu item.

16. An arc-based menu fabrication method that facilitates improved menu item selection comprising:
constructing an action area around a pointer, the pointer is located at or about the center of the action area;
subdividing half of the circle into sections, the number of sections is based on a desired number of menu items to present to a user;
spatially arranging the menu items with respect to the sections in the half circle; and
forming extensions to the menu items by extending lines from upper and lower corners from the same side of each menu item to the center of the circle to create a greater selectable area for each menu item and to make the menu items visually distinct.

17. The method of claim 16, further comprising dynamically arranging the menu items based in part on a position of the menu when activated by the user for viewing or selection therefrom.

18. The method of claim 16, spatially arranging the menu items evenly around the half circle based at least in part on a number of menu items to present to the user.

19. The method of claim 16, further comprising presenting at least a subset of the menu items when the menu is activated by the user.

20. The method of claim 19, further comprising highlighting each menu item as the pointer passes over it.
